(19) United States
(12) Patent Application Publication
(10) Pub. No.: US 2021/0120751 A1
(43) Pub. Date: Apr. 29, 2021

(54) MULTI-FUNCTIONAL POTTING VESSEL WITH GROWTH AID THEREIN

(71) Applicant: Justin Simone, Pepperell, MA (US)

(72) Inventor: Justin Simone, Pepperell, MA (US)

(21) Appl. No.: 16/662,738

(22) Filed: Oct. 24, 2019

(51) Int. Cl. A01G 24/22; A01G 9/02; A01G 7/06

(52) U.S. Cl. CPC A01G 24/22; A01G 7/06; A01G 9/02

(57) ABSTRACT

The present disclosure is related to improved potting vessels, and more specifically to an improved multi-functional textile vessel. The vessels disclosed include novel textiles, including composites of natural and synthetic materials, and microencapsulated growth aid. In a preferred embodiment, Aloe Vera is microencapsulated in a textile vessel to enhance plant growth and yield. The disclosed vessels further provided novel mixing systems and on-board tie-down systems that enhance the overall efficiency of planting processes.

### FIELD OF TECHNOLOGY

The present disclosure relates to a multi-functional bio-composite textile potting vessel for increasing and improving growth, yield, and efficiency of plants. The vessel may provide to the plant therein a growth aid, may be biodegradable, may assist a user in mixing soil, and may include an on-board tie down system.

### SUMMARY OF DISCLOSURE

The present disclosure relates to potting vessels that overcome the shortcomings associated with those of prior art vessels. In addition, the present disclosure teaches novel vessels and growth aids for improving plant growth and yield and increasing planting efficiency.

In accordance with aspects and embodiments, a potting vessel is disclosed comprising a cavity having an open end and formed by at least one side wall and a base, wherein the at least one side wall and the base are comprised of a textile and the textile has a growth aid infused therein. The textile of the vessel is selected from the group consisting of polypropylene, hemp, and combinations thereof, is porous, and includes apertures for lateral root growth. The growth aid infused in the textile is infused via microencapsulation and the preferred growth aid is Aloe Vera.

In accordance with embodiments, the vessel may include a drawstring at its opening that can be manipulated the close the cavity. The vessel may further include a tie-down system positioned at and around the open end of the cavity and affixed to the at least one side wall. The tie down system may be removably affixed to the at least one side wall by for example hook and loop fastener flaps. In accordance with aspects and embodiments, the disclosed potting vessel may include at least two handles affixed to the at least one side wall and at least one handle affixed to the base, and plurality of mixing markers stitched onto the side walls to aid in mixing potting mediums within the vessel.

### BACKGROUND

Several steps are required to grow a healthy plant from seed to fully mature plant, the first of which includes choice of appropriate potting vessel and medium. Most seeds are first potted in small vessels with an optimal mixture of potting mediums that must be mixed according to the needs of the need such that the seed can germinate into a seedling and develop roots. As the plant goes through growth stages from seedling to vegetative to budding, the plant may require different nutrients. Further, its height may require management via tie downs. The plant may ultimately require a larger vessel such that its roots can continue to grow laterally, necessitating repotting.

Existing potting vessels, sometimes referred to herein as simply as “vessels” or “pots” suffer from several drawbacks. Traditional hard-sided vessels, that is, ceramic, stone, and terracotta, potting vessels, are heavy and expensive. Soft-sided vessels, i.e., those made of non-woven polypropylene, are lighter in weight but are often made of non-biodegradable materials, making them undesirable to many go-green enthusiasts. Further, existing polypropylene materials have proven to be of inconsistent and poor quality. Regardless of vessel material, potting medium cannot easily be mixed within existing vessels. Potting medium must first be mixed outside of the vessel and poured in, leading to a messy and inefficient potting process. When a seed germinates and its height must be managed, the plant must be tied down to the vessel. When the plant outgrows the vessel, the plant must be repotted. This process requires all tie downs to be removed, which often damages the plant. Once repotted in a larger vessel, the plant must then be re-tied down. Existing vessels also do not provide root systems with much aeration and as the plant grows in size, the roots often grow circularly within the diameter of the pot rather than in a desired lateral direction. Moreover, supplying additional nutrients to the plant can be difficult, leading to less than desired growth and yield.

In addition to the steps that an agriculturalist or horticulturist must actively take to geminate seeds, plants naturally encounter barriers to growth, when growing wild and even when under human care, including but not limited to lack of available nutrients, exposure to bacteria, viruses, parasites, and predators, draught, extreme temperatures, and other natural and ecological phenomena detrimental to growth.

The present disclosure provides a novel vessel for improving plant growth and yield and enhancing overall efficiency in the planting process. The vessel disclosed thus aids in the mixing of potting medium, plant height management, and repotting. Further, the disclosed includes novel growth aid in a novel delivery mechanism that facilitates growth and improves yield. In some embodiments, the entire vessel is biodegradable and can be directly potted into outdoor soil.

Aloe Vera, also referred to herein simply as “aloe”, is comprised of several constituents known to have active properties. These constituents include vitamins, enzymes, minerals, sugars, lignin, anthraquinones, fatty acids, hormones, saponins, salicylic acids, and amino acids. The medicinal properties of aloe and its constituents has thus been studied with respect to the benefits that they made provide to mammalian subjects.

Aloe contains vitamin A, also known as beta-carotene, and vitamins C and E, which are known antioxidants. Aloe also contains vitamins B12, folic acid, and choline. Antioxidants are an important line of defense to combatting harmful free radicals. Free radicals are toxic byproducts of oxygen metabolism that can cause damage to cells via oxidative stress. The antioxidants present in aloe thus have the ability to counteract the harmful effects of free radicals.

The enzymes in aloe include aliiase, alkaline phosphatase, amylase, bradykinase, carboxypeptidase, catalase, cellulase, lipase, and peroxidase. These enzymes have the ability to break down sugars and fats and bradykinase in particular has anti-inflammatory properties.

The minerals present in aloe include calcium, chromium, copper, selenium, magnesium, manganese, potassium, sodium, and zinc. These minerals are crucial to certain cellular functions, are essential to some enzymatic systems, and required of certain biosynthetic pathways. The sugars in aloe include monosaccharides in the form of fructose and glucose and polysaccharides in the form of glucomannans and polymannose. These sugars are derived from the mucilage layer of the plant and are known as mucosaccharides. The most prominent monosaccharide is mannose-6-phosphate and the most common polysaccharide is beta-(1,4)-acetylated mannan. Acemannan, a prominent glucomannan, has recently been identified, and a glycoprotein, alprogen, having antiallergic and properties has also been identified. C-glucosyl chromone has also been isolated from Aloe Vera gel and has been shown to have anti-inflammatory properties.

Aloe provides 12 anthraquinones. Anthraquinones are phenolic compounds known to have several properties, including antibacterial and antiviral activity, as well as laxative properties. Aloe further includes the fatty acid steroids cholesterol, campesterol, β-sitosterol, and lupeol. These fatty acids show anti-inflammatory activity and lupeol has shown antiseptic and analgesic properties.

Aloe also contains hormones including auxins and gibberellins that aid in wound healing and have anti-inflammatory activity. Aloe further includes salicylic acid which is known to possess anti-inflammatory and anti-bacterial properties. Lignin is considered an inert substance in aloe, but when included in topical preparations, enhances the penetrative effect of other ingredients in into the skin. Saponins, also found in aloe, form about 3% of the aloe gel and have antiseptic properties.

Each of the constituents discussed however may provide benefits to agricultural and horticultural plants. Plants have been shown to benefit from antibacterial, antifungal, antiviral and antiseptic compounds, as well as compounds providing nutrients in the form of vitamins, minerals, and sugars. Moreover, it has been shown the salicylic acid is involved in local and systemic plant defense responses against pathogens and plays a role during stresses, including during drought, chilling, heat, heavy metal toxicity, and osmotic stress. It also has the ability to warn neighboring plants of danger via volatilization. Thus, by delivering aloe to the root systems of plants either directly or via potting medium, the constituents in aloe may aid in growth and yield.

There thus is a need for a system to deliver aloe to plants efficiently such that plants can benefit from its natural properties. Thus, the present vessel includes textile having an Aloe Vera included on or infused therein for delivery to plants potted in the disclosed vessel.

### BRIEF DESCRIPTION OF THE FIGURES

FIG. 1 is a perspective view of a potting vessel in accordance with aspects and embodiments of the present disclosure;

FIG. 2 is a side view of a potting vessel in accordance with aspects and embodiments of the present disclosure;

FIG. 3 is a top view of a potting vessel in accordance with aspects and embodiments of the present disclosure;

FIG. 4 is a side view of a potting vessel in accordance with aspects and embodiments of the present disclosure; and FIG. 5 is a perspective view of a potting vessel in accordance with aspects and embodiments of the present disclosure.

### DETAILED DESCRIPTION

In accordance with aspects and embodiments, a soft sided potting vessel is disclosed. The soft-sided potting vessel may be comprised of one or more textiles. In accordance with embodiments, the vessel may comprise synthetic or natural fibers, or may be a composite of both synthetic and natural fibers. In some embodiments, the vessel may be polypropylene. In accordance with other embodiments, the vessel may by a geotextile, and may for example be a non-woven geotextile, including non-woven needle punched hemp. In some embodiments, the vessel may be a combination of polypropylene and needle punched hemp and may comprise a layer of hemp and a layer of polypropylene laminated together to form a single composite fabric.

Alternatively, the vessel may consist solely of biodegradable materials and may be potted directly into the ground and will degrade naturally over time. Alternatively, the vessel may comprise a two part system comprising of a first layer of polypropylene and a second layer of biodegradable textile that can be separated. The polypropylene layer may form the exterior of the vessel and the biodegradable layer may be placed on the interior of the vessel. The biodegradable layer may be removable such that the plant can be removed from the outer polypropylene layer, contained with the biodegradable layer, and re-potted outdoors. Non-biodegraded portions of the vessel may be reused, and biodegraded portions may be replaced upon each reuse, including any materials having the growth aids discussed herein. Additionally, one or more of the textiles may include porous holes to allow for air pruning and lateral root growth. Providing holes for lateral root growth ensures that roots grow outward rather than circling inside the pot, causing root bound.

The color of the disclosed vessels may further be selected to provide temperature control of the root systems of plants potted therein. The vessels may, for example, have a color designed to either reflect or absorb light. Dark colors, for example, black may be used to absorb light to increase temperature at the roots for use in colder climates. Lighter colors, for example, tans and whites, may be selected to reflect light to reduce the temperature at the roots, and may be used in hotter climates. Tan colored pots may be able to reduce the pot temperature by up to about 2-3 degrees, and white colored pots may be able to further reduce the pot temperature.

In accordance with aspects and embodiments, the vessel may further include an on-board tie down system. The disclosed vessel thus enables a plant to be tied down to the vessel in which it is planted rather than to an external support. The disclosed on-board system is advantageous to external systems in that external systems often result in tears and damage to the plant and inhibit mobility. This enables the tie downs to be continuously maintained while retaining the ability to freely move the plant and vessel.

In accordance with aspects and embodiments, the vessel may include features than facilitate efficient potting medium mixing. In accordance with embodiments, the vessel includes measuring markings so that given quantities of mediums can be placed into the vessel without the need for external measuring. In further embodiments still, the vessel includes a closure that seals the system such that the layers of different potting mediums placed into the vessel can be blended and mixed prior to planting. These features advantageously save on time and cost and enhance efficiency.

In accordance with aspects and embodiments, the disclosed vessel includes a growth aid. The growth aid may facilitate growth and yield. In accordance with aspects and embodiments, the growth aid is Aloe Vera, however other known growth aids may be used alone or in combination with aloe. One or more of components of the aloe may aid in the plant's defense against bacteria, yeast, mold, and viruses, harsh climate, toxins, or other environmental stresses, resulting in improved growth and yield.

The growth aid may be included in a textile of which the vessel is comprised and may for example by microencapsulated in the textile. Microencapsulation is well known in the art and involves encapsulating active agent, in this case, the growth aid, in airtight and waterproof shells to form microcapsules. The microcapsules are bonded with fabric according to methods known in the art and a shell protects the enclosed material from evaporation and contamination. As the fabric is contacted, that is, as it is rubbed against, pushed on, or touched, the shell of the capsule breaks, thereby releasing the growth aid. Additional agents may also be included in the textile, via microencapsulations of via any other techniques known in the art. These agents may include, but are not limited to, pesticides, phosphates, nitrogen, and any other agent potentially beneficial to plant growth and health.

In accordance with aspects and embodiments of the presently disclosed potting vessel comprised of a textile including microencapsulated aloe, the aloe may be delivered to the plant in a several different ways. In some embodiments, potting medium may be added to the vessel and mixed therein. The force of the introducing and mixing the potting medium into the vessel may cause the capsules to break and release the ale into the soil. The aloe is then absorbed through the plant's root system. Alternatively, a plant potted in the disclosed vessel may grow such that its root system exerts pressure on vessel, including the microencapsulations included therein. This pressure will cause the capsules to break and the aloe with soak the soil. The aloe will then be taken up via the root system.

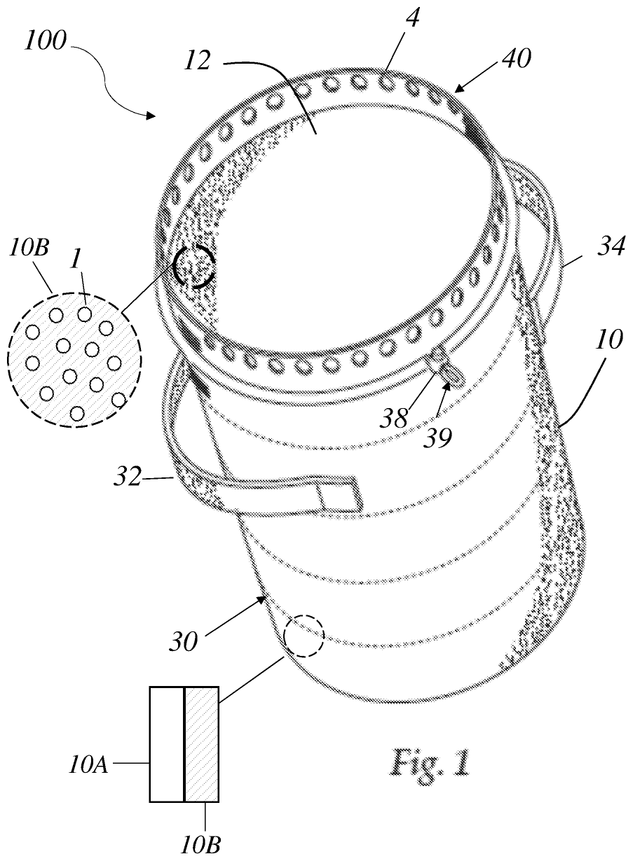

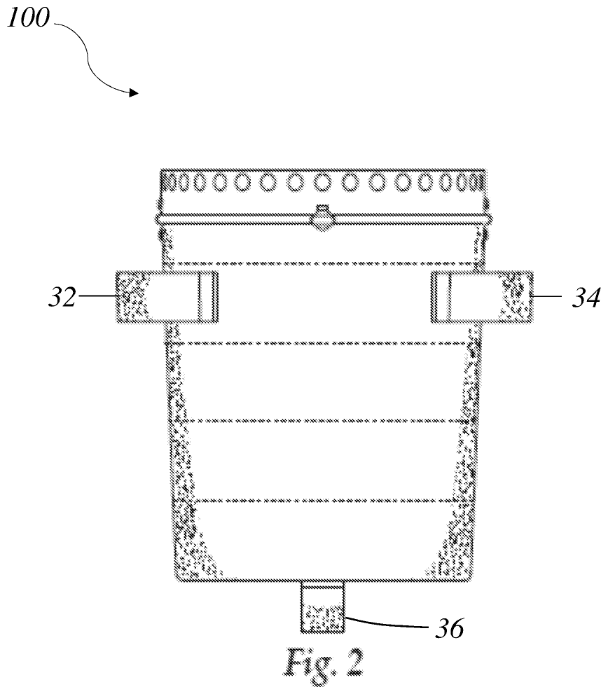

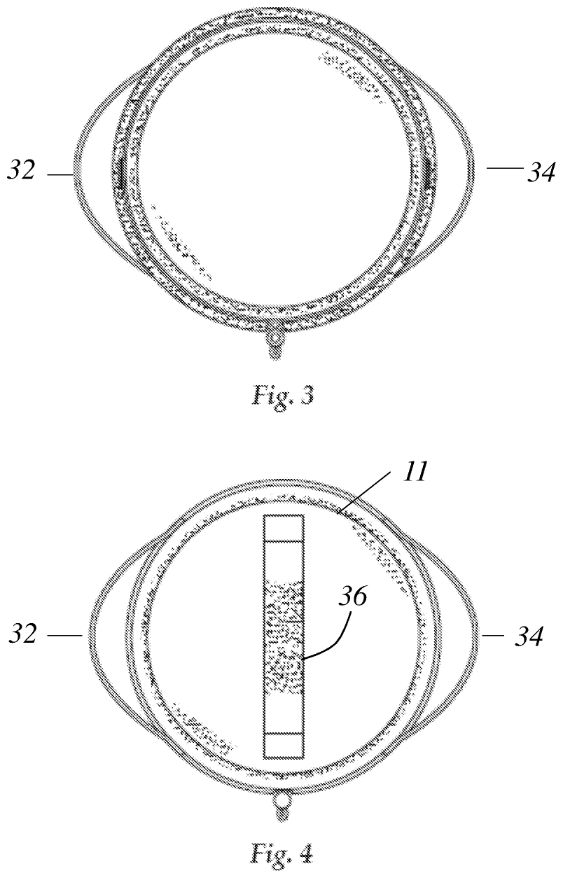

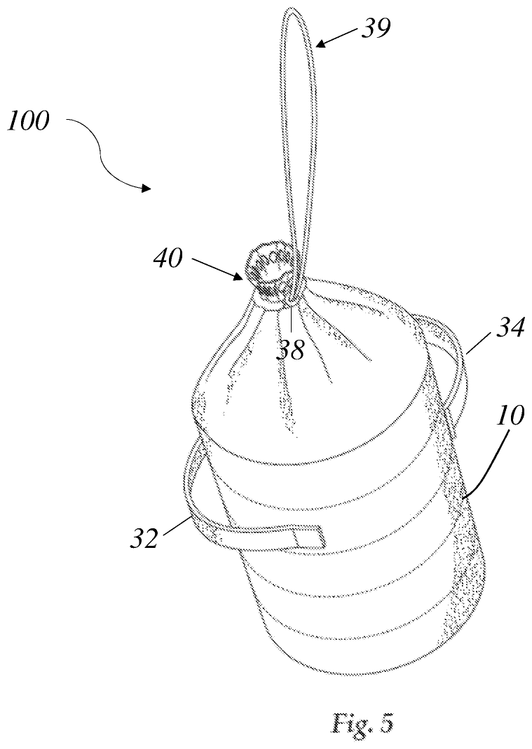

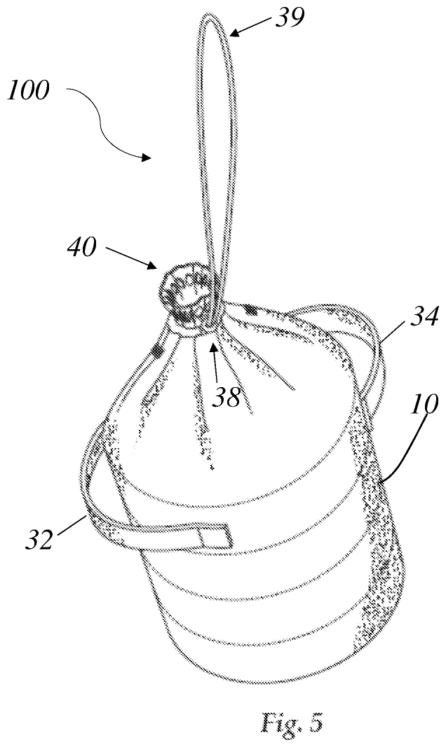

A vessel in accordance with aspects and embodiments is shown in FIGS. 1-5. Vessel 100 is formed of textile 10. Textile 10 forms cavity 12 having bottom surface 11. Textile 10 may be a composite of hemp fiber and polypropylene and includes microencapsulations of aloe 1. Textile 10 may be a lamination of a hemp fiber textile 10 B and of a non-woven polypropylene textile 10A. For example, the outer layer of vessel 100 may be a polypropylene geotextile 10A and the inner layer may be a hemp fiber textile including 10A microencapsulated growth aid in microencapsulations 1. The polypropylene layer 10B and hemp layer 10A may be laminated together to form a single sheet of material 10 by methods known in the art. Alternatively or in addition to the use of such laminations, vessel 100 may be formed from a textile sewn or otherwise formed from several materials, where one of which is a hemp fiber or one of which is the hemp and polypropylene lamination. Textile 10 may be porous and may for example include porous holes (not shown). The porosity of the fabric may allow root systems of plants potted in vessel 100 to pass through to textile 10 and allow for outward lateral growth. If textile 10 is not porous enough to allow for root growth, separate root growth apertures may be included in textile 10 to allow for such lateral growth. Vessel 100 is outfitted with side handles 32 and 34. Referring also to FIGS. 2 and 4, vessel 100 has bottom handle 36.

Vessel 100 further includes measuring lines 30. Exemplary vessel 100 shows 5 lines 30 as sewn lines on textile 10 each at a 20% volume mark of vessel 100. Measuring lines 30 may however be spaced in alternative configurations and be marked on vessel 100 in any manner known in the art. Vessel 100 includes drawstring 39 threaded around the circumference of the opening of cavity 12 and drawstring lock 38.

Vessel 100 has tie-down system 40 at end of vessel 100 opposite surface 12 around the opening of cavity 12. Tie-down system 40 includes apertures 4. In some embodiments, tie down system 40 may be removable, and may be affixed to fabric 10 via fasteners. Tie-down system 40 may, for example, be affixed to fabric 10 via hook and loop fastener flaps. Tie-down system 40 may be removed for mixing potting medium and replaced after mixing and planting has been performed.

Referring specifically to FIG. 5, when mixing is to be performed, potting medium is placed into cavity 12 of vessel 100. Various potting mediums may be placed in desired amounts into vessel 100 using measuring lines 300 as a guide. Sewn lines 30 advantageously appear on both the inside and outside of the textile, facilitating easy measurements. Once the desired types and amounts of materials have been placed into vessel 100, drawstring 39 is pulled to close the mouth of cavity 12. Drawstring lock 38 locks drawstring 39 in place, effectively creating a sealed vessel. Side handles 32 and 34, as well as bottom handle 36 (shown in FIGS. 2 and 4) can then be used to shake the vessel to effectively mix the potting mediums. In so doing, the microencapsulations of growth aid on textile 10 also burst and soak the potting medium with growth aid. The drawstring lock 38 is then released and the mouth of cavity 12 is re-opened by slackening drawstring 39. A plant is potted in the soaked potting medium in cavity 12 of vessel 100 and the root system of the plant is able to soak up the growth aid.

It will be appreciated that the textiles including the microencapsulated growth aids of the present disclosure may be used separately from potting vessels. For example, sheets of material having microencapsulated growth aid may be used as a sack to store and transplant plants into other vessels or the ground conveniently while advantageously enhancing growth. Alternatively, the textiles including microencapsulated growth aid could be layered in a vessel or when planting a plant in the ground in such a manner to enhance growth. The textiles including the microencapsulated growth aids of the present disclosure can be cut to size according to desired use and used in manners consistent with desired applications.

Although certain representative embodiments and advantages have been described in detail, it will be apparent to those skilled in the art that various modifications and variations can be made in the present disclosure without departing from the scope or spirit of the disclosure. Other embodiments of the disclosure will be apparent to those skilled in the art from consideration of the specification and practice of the apparatuses and methods disclosed herein. It is intended that the specification and examples be considered as exemplary only.

What is claimed is:

1. A potting vessel comprising:
a cavity having an open end and formed by at least one side wall and a base, wherein the at least one side wall and the base are comprised of a textile and the textile has a growth aid infused therein; and
at least two handles affixed to the at least one side wall.

2. The potting vessel of claim 1, wherein the textile is selected from the group consisting of polypropylene, hemp, and combinations thereof.

3. The potting vessel of claim 2, wherein the textile is porous.

4. The potting vessel of claim 3, wherein the textile includes apertures for lateral root growth.

5. The potting vessel of claim 4, wherein the growth aid is infused in the textile via microencapsulation.

6. The potting vessel of claim 5, wherein the growth aid is Aloe Vera.

7. The potting vessel of claim 6, further comprising a drawstring encircling the opening of the cavity.

8. The potting vessel of claim 7, wherein the drawstring can be manipulated to close the open end of the cavity.

9. The potting vessel of claim 8, further comprising a tie-down system positioned at and around the open end of the cavity and affixed to the at least one side wall.

10. The potting vessel of claim 9, wherein the tie-down system is removably affixed to the at least one side wall.

11. The potting vessel of claim 10, where the tie-down system is affixed to the at least one side wall with hook and loop fastener flaps.

12. A potting vessel comprising:
a cavity having an open end and formed by at least one side wall and a base, wherein the at least one side wall and the base are comprised of a textile;
at least two handles affixed to the at least one side wall; and
at least one handle affixed to the base.

13. The potting vessel of claim 12, where the at least one side wall includes a plurality of mixing markers.

14. The potting vessel of claim 13, wherein the plurality of mixing markers are stitched lines.

15. The potting vessel of claim 14, further comprising a drawstring encircling the opening of the cavity.

16. The potting vessel of claim 15, wherein the drawstring can be manipulated to close the open end of the cavity.

17. The potting vessel of claim 16 further comprising a tie-down system positioned at and around the open end of the cavity and affixed to the at least one side wall.

18. The potting vessel of claim 17, wherein the textile is selected from the group consisting of polypropylene, hemp, or combinations thereof.

19. The potting vessel of claim 18, wherein the textile further includes Aloe Vera microencapsulations.

20. The potting vessel of claim 19, wherein the textile is porous and includes apertures for lateral root growth.
